(19) United States
(12) Patent Application Publication
(10) Pub. No.: US 2011/0089261 A1
(43) Pub. Date: Apr. 21, 2011

(54) Spray gun assembly

(76) Inventors: Alfred Göhring, Salem (DE); Hermann Probst, Ravensburg (DE); Elmar Krayer, Langenargen (DE); Jens Ulbrich, Friedrichshafen (DE)

(21) Appl. No.: 12/928,611

(22) Filed: Dec. 14, 2010

Related U.S. Application Data
(63) Continuation-in-part of application No. 11/702,855, filed on Feb. 6, 2007, now abandoned.

(30) Foreign Application Priority Data
Feb. 11, 2006 (EP) 06002791

(51) Int. Cl. B05B 7/26

(52) U.S. Cl. 239/310

(57) ABSTRACT

A spray gun assembly for spraying paint or similar viscous media includes a gun housing provided with a handle, and a reservoir tank removably attached to the gun housing, the reservoir tank being a storage container adapted for removable attachment to the spray gun housing and comprising a paint can or a paint bag. The storage container is directly secured to a projection extending from the gun housing.

### CROSS-REFERENCE TO RELATED APPLICATION

This application is a continuation-in-part of application Ser. No. 11/702,855, filed Feb. 6, 2007 in the names of Alfred Wiring, Hermann Probst, Elmar Krayer and Jens Ulbrich.

### BACKGROUND OF THE INVENTION

1. Field of the Invention

The present invention relates to a spray gun assembly for spraying paints and similar viscous media that can be propelled pneumatically or electrically, the assembly comprising a gun housing for accommodating a propulsion mechanism, components of the spray gun being adapted for effecting mixture and/or metering, a handle projecting from the gun housing, and a reservoir tank removably attached to the gun housing for holding the medium to be processed, with means for introducing the medium from the reservoir tank into the gun housing of the spray gun.

2. Description of the Prior Art

Spray gun assemblies of this type have been described in numerous different configurations and have also proven their effectiveness in practice. In order to enable a medium to be processed with such spray guns, it is necessary to remove the reservoir tank from the gun housing and to fill it. This procedure is time-consuming, and the paint or other medium can easily be spilled. Furthermore, it is often essential to carry out extensive cleaning work when changing the medium to be processed, and this also takes time. However, the principal disadvantage of these spray guns is that the viscosity of the medium put into the reservoir tank has to be adapted to the particular design configurations of the spraying device by means of which the medium is to be sprayed. This requires expert knowledge and skill. Frequently, it is not possible to achieve an optimum working method with spray guns of the prior art.

The purpose of the present invention is, therefore, to provide a spray gun of the aforementioned type that enables reservoir tanks of different configurations to be reliably attached to it straightforwardly and within a short period of time, such tanks being filled with a medium that is adapted to the spray gun to be used and/or the work to be undertaken, such that it is possible to process the material immediately after the reservoir tank has been attached to the gun housing. Accordingly, setup times are practically eliminated, and it should not be necessary to undertake any cleaning work; instead, it should be possible simply to remove one reservoir tank after a working step and to seal it.

### SUMMARY OF THE INVENTION

An object of the present invention is to provide in a spray gun assembly of the aforementioned type wherein the reservoir tank is configured as a storage container that is adapted to the spray gun and adjusted to it, in particular in the form of a special paint can or paint bag, and wherein the storage container is attached directly to a projection that is preferably configured as a cover or plate that is connected to the gun housing and/or to the gun handle by a web, or can be attached to the gun projection by means of clamping elements supported against the projection.

In a simple embodiment, the storage container can be configured in the form of a metallic paint can which can be screwed directly into a thread provided in the projection by means of a thread on an edge area of the can facing a projection opening.

According to a further embodiment, an end area of the storage container facing the projection is provided with a radially projecting collar, the projection having a thread, and a clamping element configured as a clamping ring provided for clamping the storage container onto the projection, by pressing the clamping element against the projection and/or a seal inserted therein, either directly or by means of clamping arms projecting radially inwards acting on the collar.

The clamping element provided for clamping the storage container can also be configured as a hollow body for accommodating the storage container.

In accordance with a further embodiment, provision is made for the storage container to have a riser pipe, preferably arranged centrally and inserted in a recess formed in the base of the storage container, the riser pipe being directly formed onto the closing cap of the storage container and into which a riser pipe of the spray gun can be inserted when the storage container is connected, in which case the storage container may provided with one or more mixing bodies loosely inserted into it.

In order to compensate for the differing heights of storage containers, it is appropriate for one or more clip-on legs to be provided, by means of which the support surface of the storage container can be adapted to the support surface of the handle, although it is also possible to adjust the height of the storage container to the support surface of the handle, or to change the position of the handle so that the support surfaces of the storage container and of the handle extend in one plane.

In accordance with a further embodiment, the reservoir tank can be composed of a flexibly deformable bag made from an elastic synthetic material, and the storage container is provided with a sturdy flat termination flange at its end facing the projection of the gun housing, such that the bag can be inserted in a support element that can be screwed into a thread provided in the projection by means of a thread provided in the upper end area of the support element, with the possibility of clamping a projecting edge of the terminating flange in between the support element and the projection.

In a spray gun actuated by compressed air, it is appropriate for the interior of the bag and/or the space between the support element and the bag to be connected by separate ducts to an air guidance duct in the gun housing of the spray gun, so that air pressure supplies the medium to be processed to the gun housing.

Furthermore, it is advantageous for the length of the riser pipe to be adapted to the height of the storage container, for example by means of projections or intermediate pieces, and for each storage container to be supported on the projection by a plate-shaped seal provided with at least one circumferential sealing lip protruding in the direction of the storage container and which makes contact internally against the edge of the opening of a storage container.

If a spray gun is configured in accordance with the present invention, it is possible for commercially available storage containers of widely different shapes and dimensions to be attached straightforwardly and in a very short time to the gun housing, in which case the containers can contain a medium that is ready for immediate processing. Preparatory measures, such as adjusting the viscosity, are consequently no longer required, rather, the medium to be processed can be optimally adapted to the particular working implement and application during the manufacture of a paint.

Furthermore, it is beneficial that, when the spray gun configured in accordance with the present invention is used, there is scarcely any need for transferring the medium to be processed from one container to another, or any need for cleaning work. This is because the storage container can easily be removed from the gun housing following completion of a working procedure and, if necessary, sealed with the original cap, or disposed of. This means there are hardly any setup times. By offering straightforward handling in this manner, the processing of media with different consistencies is facilitated to a considerable extent without requiring additional work.

The above and other features of the invention, including various novel details of construction and combinations of parts, will now be more particularly described with reference to the accompanying drawings and pointed out in the claims. It will be understood that the particular devices embodying the invention are shown by way of illustration only and not as limitations of the invention. The principles and features of this invention may be employed in various and numerous embodiments without departing from the scope of the invention.

### BRIEF DESCRIPTION OF THE DRAWINGS

The drawings show a spray gun assembly configured in accordance with the present invention, with variously configured reservoir tanks, some of which are attached in different manners. In the drawings:

FIG. 1 shows a side elevational view of the spray gun in a partial section with a storage container screwed onto it as a reservoir tank;

FIG. 2 shows the spray gun in accordance with FIG. 1 with a storage container attached to it by a clamping ring;

FIG. 3 shows the spray gun in accordance with FIG. 1 with a storage container inserted into a hollow body;

FIG. 4 shows the spray gun in accordance with FIG. 1 with a screwed-on storage container provided with a riser pipe;

FIG. 4A shows the spray gun and container of FIG. 4 separated from each other;

FIG. 5 shows the spray gun in accordance with FIG. 1 with a storage container attached by a clamping ring;

FIG. 6 shows the clamping ring of FIG. 5 in a perspective view;

FIG. 7 shows the spray gun in accordance with FIG. 1 with a screwed-on storage container provided with a leg;

FIG. 8 shows the spray gun in accordance with FIG. 1 with a handle that is telescopically adjustable in length, and differently configured, screwed-on storage containers;

FIG. 8A shows the handle portion of the spray gun of FIG. 8 telescopically shortened for use in conjunction with a shorter container;

FIG. 9 shows the spray gun in accordance with FIG. 1 with a storage container configured as an elastic bag;

FIG. 10 shows the spray gun in accordance with FIG. 1 with a storage container that is also configured as a bag; and

FIG. 10A shows the spray gun and container of FIG. 10 separated from each other.

### DESCRIPTION OF THE PREFERRED EMBODIMENTS

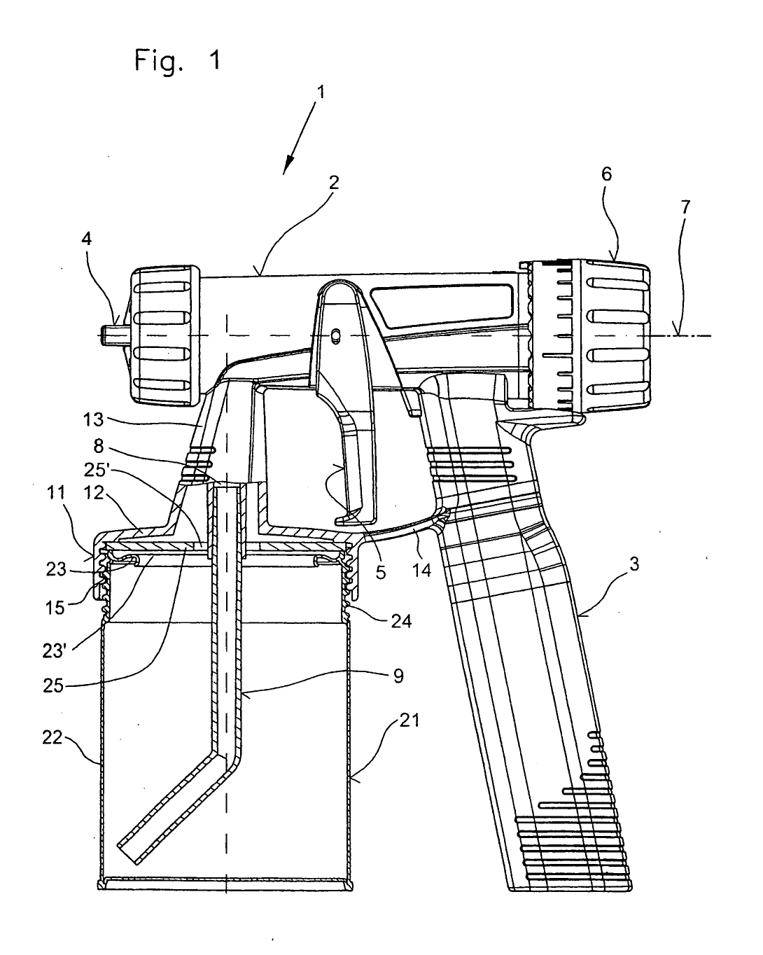

The spray gun assembly 1, shown in FIG. 1, is used for spraying paints and is similar viscous media and principally consists of a gun housing 2 for accommodating the components that are required for operating the spay gun assembly 1, a handle 3 projecting from the gun housing 2, and a reservoir tank 21 for holding the medium to be processed. An actuating lever 5 in a swivelling mounting is provided in order to trigger a spraying operation which, when it is moved, ejects the medium sucked out of the reservoir tank 21 mixed with air out of a nozzle 4 by means of compressed air supplied via a pressure line 7. An adjusting nut 6 enables the intensity of the spray jet ejected from the nozzle 4 to be adjusted. The actuating lever 5 also enables different types of propulsion systems for the spray gun assembly 1 to be operated, for example, switching on an electrical swivelling armature pump or a blower.

The reservoir tank 21 is arranged on the underside of the gun housing 2 at the level of the handle 3 in the illustrated embodiment. However, the handle can also be arranged above (not shown) and attached to the gun housing 2 so that the medium to be sprayed is supplied to the spray gun by gravity. The tank 21 comprises a storage container adapted and adjusted to the spray gun 2 in the form of a paint can 22 attached directly to the gun housing 2 of the spray gun. To make this possible, a projection 11 is formed onto the gun housing 2 that is configured as a U-shaped cover 12 and is held onto the gun housing 2, or handle 3, by means of two webs 13 and 14. A female thread 15 is worked into the projection 11 and the paint can 22 is provided with a male thread 24 in the area of the can facing a can opening 23′, so that the can 22 can be securely attached to the projection 11 directly.

When the opened can 22 is screwed in, a riser pipe 9 projecting from the projection 11 is introduced into the opening 23′ after a cap 23 has been removed, by means of which opening 23′ the medium to be processed is sucked into a duct 8 by the air flowing into the gun housing 2, the duct 8 emerging in the inside of the gun housing 2. The paint can 22 filled with a medium prepared in an appropriate manner, can therefore easily be attached to the projection 11. A seal 25 inserted between the projection 11 and the cap 23 of the paint can 22, having an opening 25′ for a riser pipe 9, thereby guarantees that the paint can 22 is connected to the spray gun 1 with a liquid-tight seal.

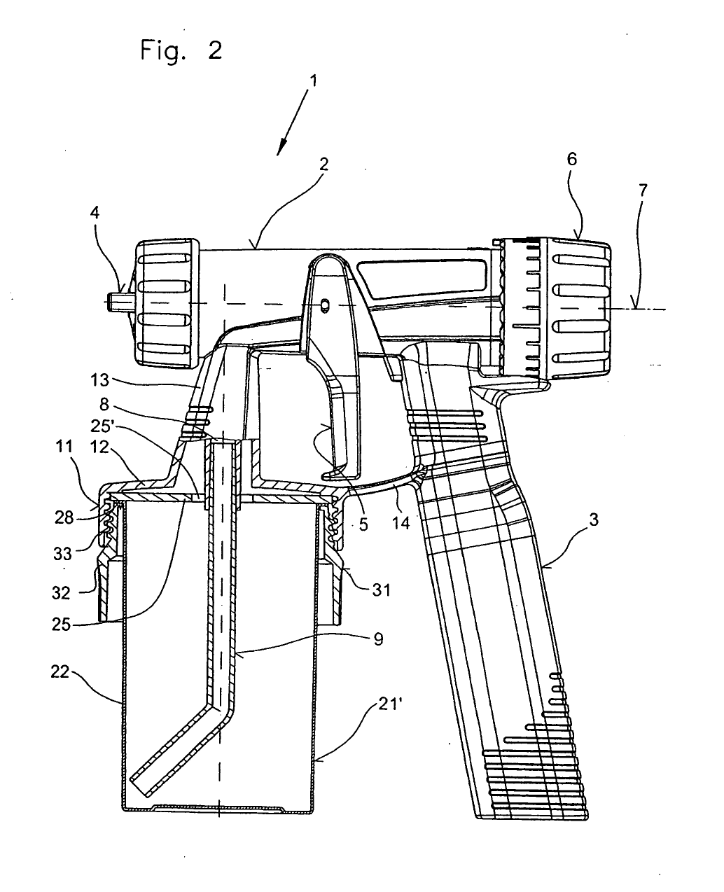

In the embodiment shown in FIG. 2, the reservoir tank 21′ that is also configured as a paint can 22 is attached to the projection 11 by means of a clamping element 31 that is configured as a clamping ring 32. The clamping ring 32 is provided with a male thread 33 for this purpose and acts on a radially projecting collar 28 of the paint can 22 so that the paint can 22 is pressed against the seal 25 inserted into the projection 11 by virtue of the fact that the clamping ring 32 is screwed onto the projection 11.

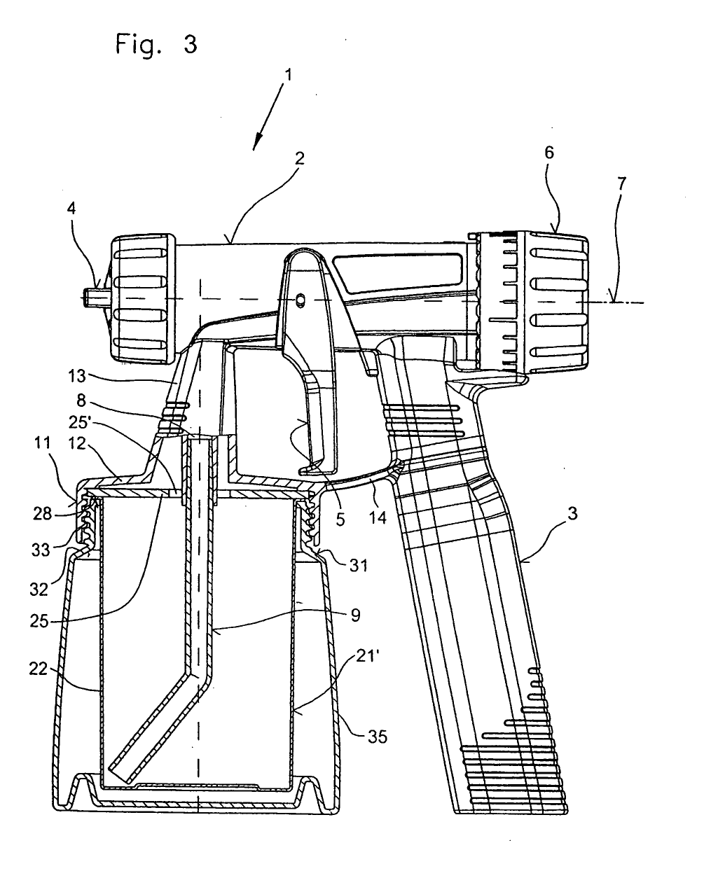

In accordance with FIG. 3, the clamping ring 32 of the clamping element 31 is provided with a hollow body 35 into which the reservoir tank 21′ is inserted. The hollow body 35 in this case is adapted to the handle 3 of the spray gun 2 so that their support surfaces run in one plane. The spray gun assembly 1 can therefore be put down securely.

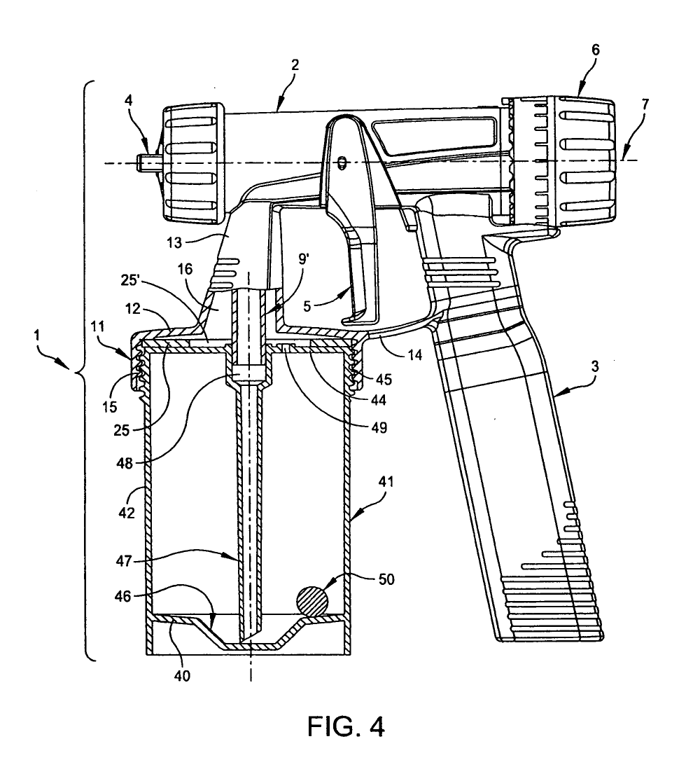

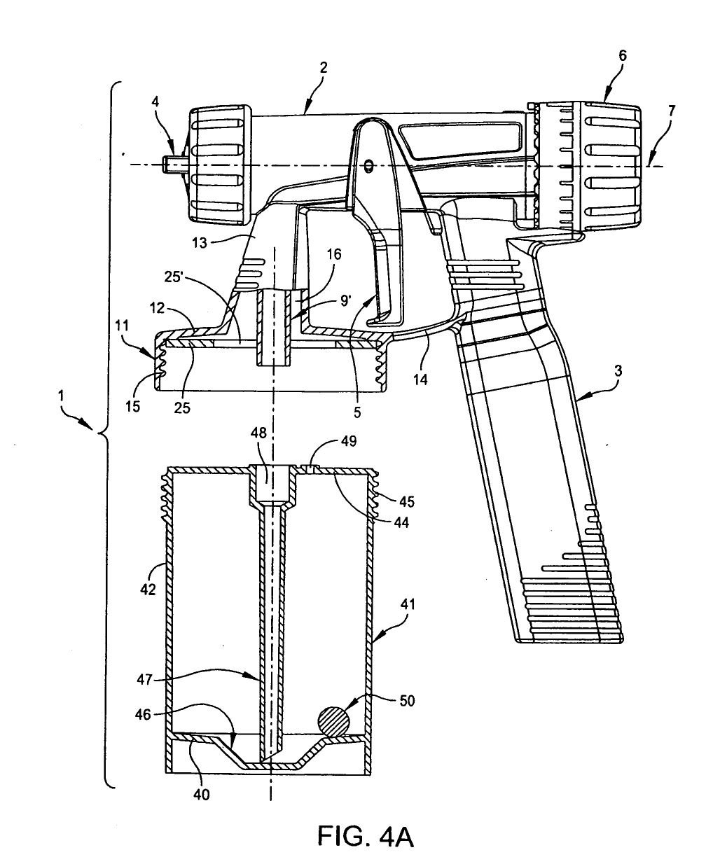

In the embodiment shown in FIGS. 4 and 4A, a reservoir tank 41 in the form of a closed paint can 42 is attached to the projection 11. For this purpose, the paint can 42 is equipped with a male thread 45 in the area of the formed cap 44 and this male thread 45 is screwed into the female thread 15 of the projection 11. In addition, the cap 44 of the paint can 42 has a centrally arranged opening 48 that is sealed during transport, for example by a plastic foil, and is penetrated by a riser pipe 9′ projecting from the projection 11 when the paint can 42 is connected. When the paint can 42 is attached, the interacting threads 15 and 45 press it against the seal 25.

The paint can 42 is additionally provided with a riser pipe 47 as an extension of the opening 48, the riser pipe 47 projecting into a recess 46 formed into the base 40 of the paint can 42. In addition, mixing bodies 50 are inserted into the paint can 42 by means of which the medium in the paint can 42 can be mixed by shaking the paint can 42 before it is screwed onto the projection 11.

The supply of medium to be processed from the paint can 42 is assisted by the compressed air pressure that is applied to the medium. This is because compressed air can enter the paint can 42 by means of a duct 16 disposed in the web 13, a process which involves the compressed air passing into the inside of the paint can 42 through an opening 25′ in the seal 25 and through one or more apertures 49 in the cap 44. The pressurisation of the medium in the paint can 42 means that the medium is forced into the riser pipe 9′ and, through this, into the gun housing 2.

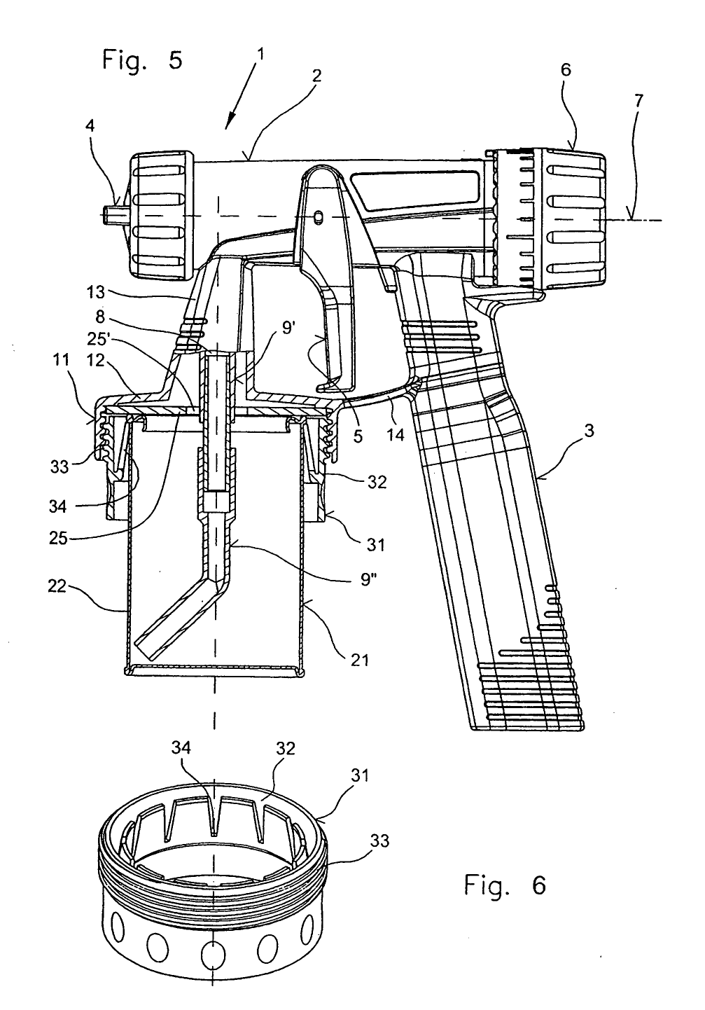

To enable paint cans with diameters that are not adapted to the projection 11 to be clamped onto it nevertheless, as shown in FIGS. 5 and 6, the clamping element 31, configured as the clamping ring 32, is equipped with spring-loaded clamping arms 34 projecting radially inwards that act on the knurled edge area of the paint can 22. The clamping arms 34 can deflect outwards, depending on the diameter of the paint can 22, whilst, nevertheless, the paint can 22 is always clamped on securely by the clamping ring 32 that has the male thread 33 and is screwed into the projection 11.

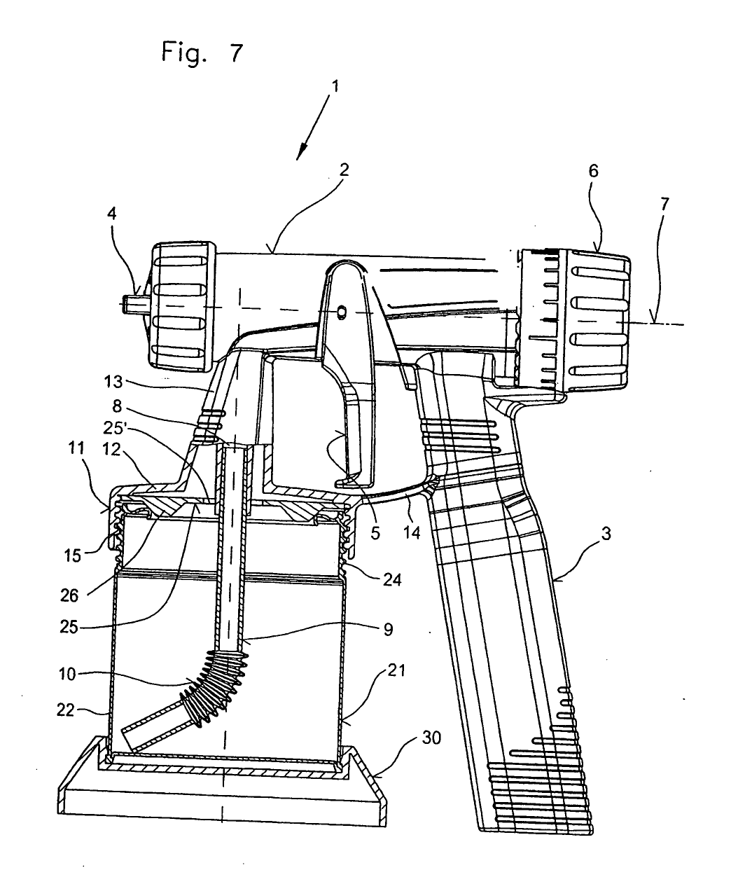

In the embodiment shown in FIG. 7, the paint can 22 provided as a reservoir tank 21, has a support 30 that extends vertically in a manner that is adapted to the paint can 22. In this way, the support surfaces of the spray gun assembly 1 in the area of the reservoir tank 21 and of the handle 3 run in the same plane. In addition, the riser pipe 9 is equipped with an elastically deformable intermediate portion 10 so that the riser pipe 9 can also be adapted to the size of whichever spray can 22 is screwed on. Furthermore, as shown in FIG. 7, the seal 25 can be provided with sealing lips 26 that make contact on the inside with the opening 25′ in the cap 23 of the paint can 22. In this way, a reliable seal is guaranteed.

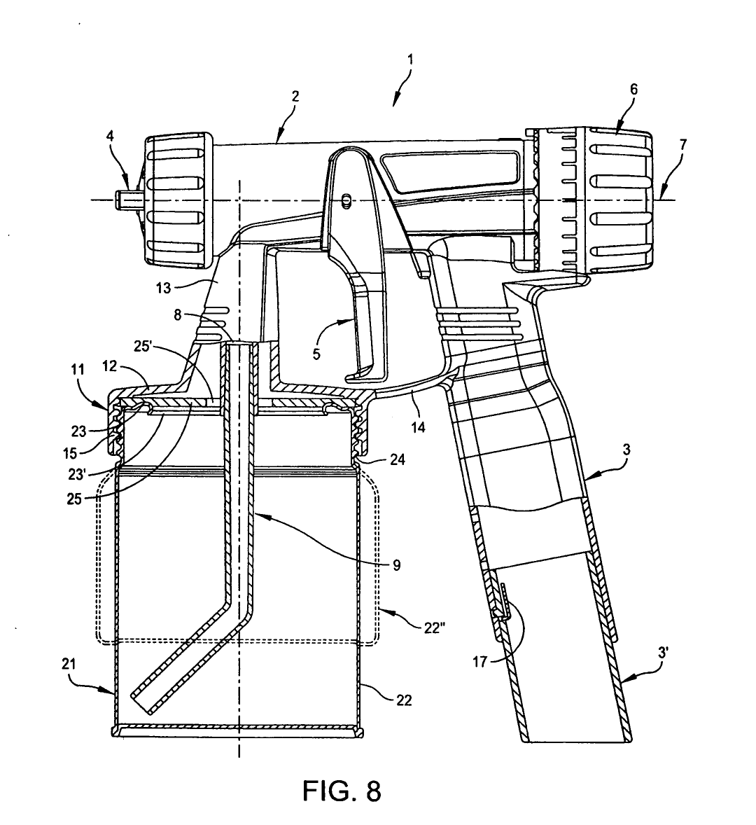

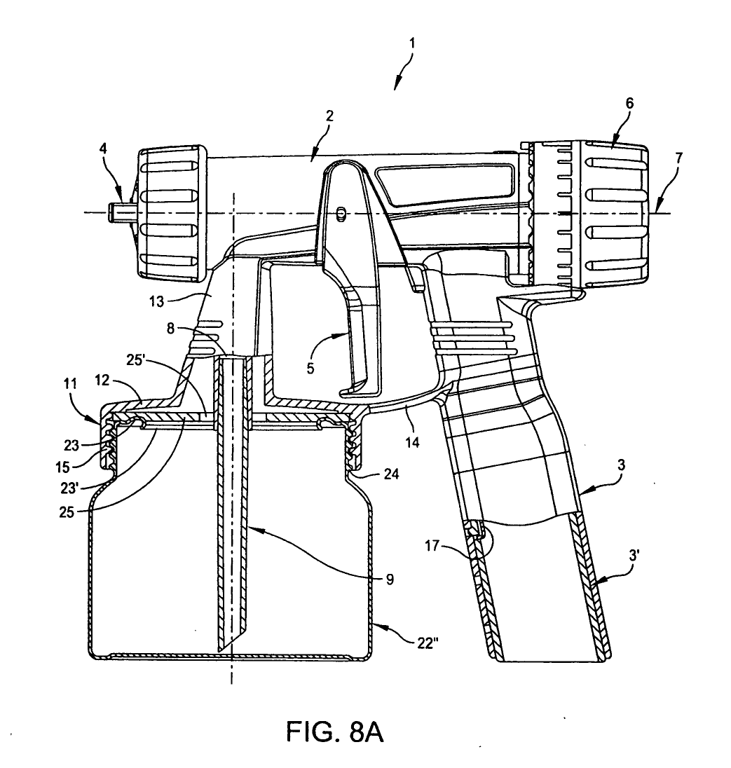

In order to ensure that the spray gun 1 stands securely, even with paint cans 22 and 22′ of differing heights, the sample embodiment shown in FIGS. 8 and 8A has the handle 3 of the spray gun 1 provided with an insert 3′ that can be locked on the handle 3 in different height positions in accordance with the height of the drawn paint cans 22 and 22′, e.g. with the help of a spring detent 17.

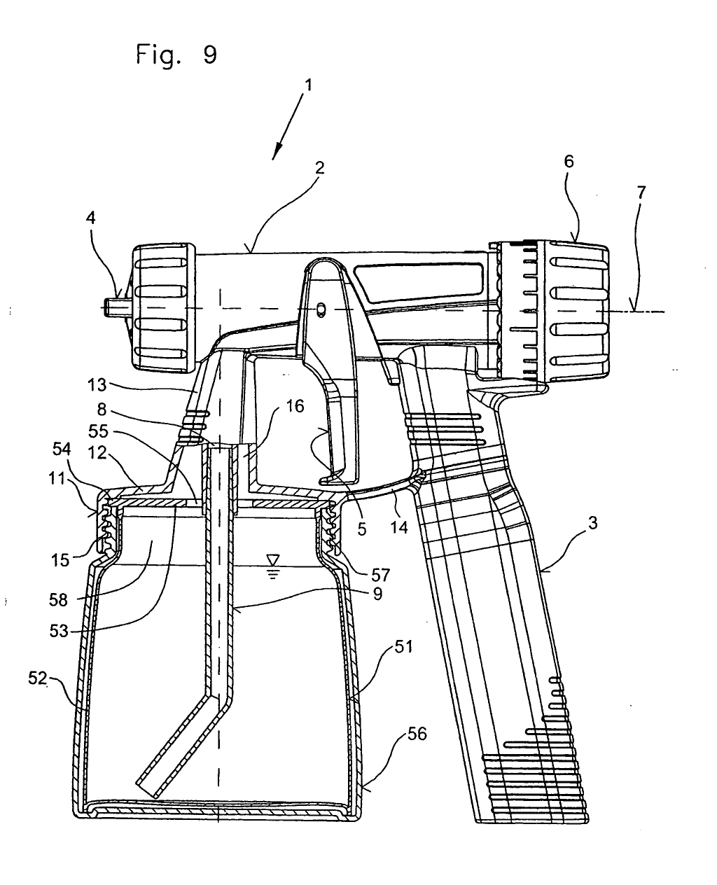

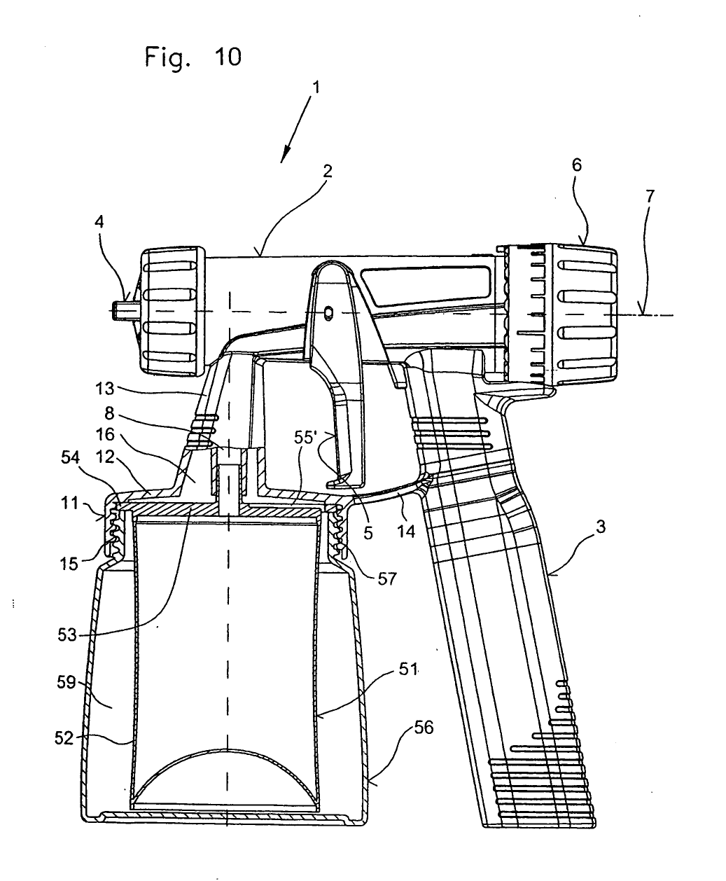

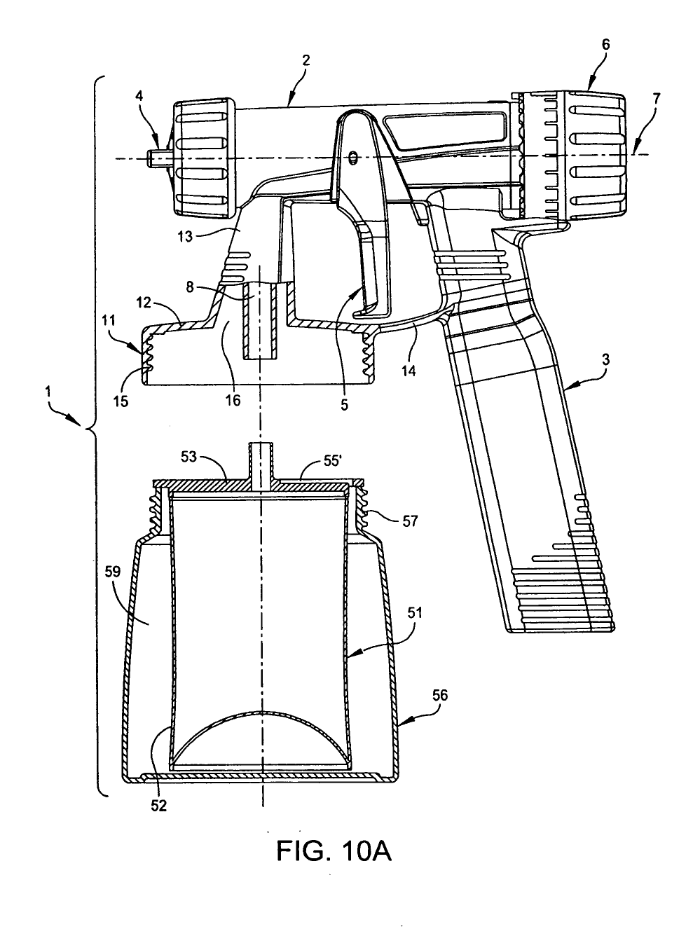

In accordance with the depictions in FIGS. 9 and 10, an elastically deformable paint bag 52 is provided as the reservoir tank 51. The top end of the paint bag 52 is equipped with a flat, rigid flange 53 made from metal or plastic, with radially projecting edges 54.

The paint bag 52 is secured to the projection 11 by means of a pot-shaped container 56 that is provided with a male thread 57. Screwing the container 56 into the projection 11 causes the flange 53 of the paint bag 52 to be clamped and pressed against the projection 11.

To supply the medium contained in the paint bag 52 to the spray gun 1, the medium stored in the paint bag 52 is pressurised by compressed air in accordance with FIG. 9. The compressed airs flows from the gun housing 2 into the interior 58 of the paint bag 52 through the duct 16 provided in the web 13 and a passage opening 55 worked into the flange 53. In the sample embodiment shown in FIG. 10, on the other hand, a space 59 between the container 56 and the paint bag 52 is pressurised by compressed air that is able to enter the space 59 through the passage opening 55 formed in the flange 53. The pressure applied to the medium in the paint bag 52 or to the bag 52 itself means that the medium is forced into the gun housing 2 and can then be processed by means of the spray gun assembly 1.

It will be understood that many additional changes in the details, materials, steps and arrangements of parts, which have been herein described and illustrated in order to explain the nature of the invention, may be made by those skilled in the art within the principles and scope of the invention as expressed in the appended claims.

What is claimed is:

1. A spray gun assembly comprising:
a spray gun having a handle portion, a housing, a pressure line for admitting compressed air into the housing, a nozzle for discharging a mixture of the compressed air and a liquid, and an actuating lever for controlling mixture discharge through the nozzle, and a web extending from the housing and having therein a duct and a first riser pipe in communication with the pressure line and the nozzle, the duct having at a free end thereof a projection portion; and
a container adapted for connection to the projection portion, said container having an opening in a first end portion thereof and a second riser pipe extending from the opening to a bottom portion of said container, the second riser pipe being open at both ends thereof;
wherein the container opening is adapted to receive the spray gun riser pipe, and
wherein a cap portion of said container defines an aperture in communication with the spray gun housing duct, such that compressed air is flowable from the pressure line, through the duct and the container aperture and into said container, and
said container is attachable to, and removable from, said spray gun; and when said spray gun and said container are connected to each other, the container riser pipe is in communication with the spray gun riser pipe and the spray gun riser pipe is in communication with the pressure line and the nozzle.

2. The spray gun assembly in accordance with claim 1, wherein the spray gun projection portion is provided with first threads thereon and said container is provided with second threads thereon, the first and second threads being inter-connectable to releasably fix said container to said gun.

3. The spray gun assembly in accordance with claim 2 and further comprising a sealing member disposed in the projection and engageable by said container, said sealing member having a central opening therein exposed to the container riser pipe opening and the aperture.

4. The spray gun assembly in accordance with claim 1, wherein the container bottom portion is provided with a recess, and a distal end of the container riser pipe extends into the recess.

5. The spray gun assembly in accordance with claim 1, wherein the projection portion is further fixed to said spray gun handle by said web extending therebetween.

6. The spray gun assembly in accordance with claim 1 and further comprising a discrete mixing body disposed in said container and freely moveable therein.

7. The spray gun assembly in accordance with claim 1, wherein said handle portion is telescopically extendible and retractable so as to position a bottom of said handle portion substantially even with bottoms of different sized containers.

8. A spray gun assembly comprising:
a spray gun having a handle portion, a housing, a pressure line for admitting compressed air into the housing, a nozzle for discharging a mixture of the compressed air and a liquid, an actuating lever for controlling mixture discharge through the nozzle, and a web extending from the housing and having therein a duct and within the duct a first riser pipe in communication with the pressure line and the nozzle, the duct having at a free end thereof a projection portion; and
a flexible container having an opening in a rigid flange member at a first end thereof, and a second riser pipe extending from the flange member opening and adapted to engage and closely conform to the first riser pipe, the second riser pipe being open at both ends thereof to interconnect the interior of the first riser pipe with the interior of said flexible container;
a rigid container adapted for connection to the projection portion of the spray gun duct;
said flexible container being disposed within said rigid container, said flexible container having at a first end thereof the rigid flange member having outer edge portions extending beyond sides of said flexible container, the outer edge portions being engageable with the spray gun projection portion to secure said flexible container to said spray gun, with the flexible container riser pipe extending from the rigid flange member and adapted for the interconnection of said flexible container and the spray gun first riser pipe.

9. The spray gun assembly in accordance with claim 8, wherein the projection portion and said rigid container are each provided with threads interconnectable with the each other to secure said rigid container and said flexible container therein to the projection portion.

10. The spray gun assembly in accordance with claim 8, wherein the rigid flange is provided with a passage opening formed therein, the passage opening interconnecting the spray gun duct and space between said rigid container and said flexible container; wherein the compressed air is flowable from said gun housing, through the gun duct and the rigid flange passage opening and into a space between said rigid container and said flexible container to apply pressure on said flexible container.

11. The spray gun assembly in accordance with claim 8, wherein the projection portion is further fixed to said spray gun handle portion by a web extending therebetween.

12. The spray gun assembly in accordance with claim 8, wherein the projection portion and said rigid container are threadably connectable to each other.

13. The spray gun assembly in accordance with claim 8, wherein the handle portion is telescopically extendible and retractable so as to position a bottom of said handle portion substantially even with bottoms of different sized rigid containers.
